(19) United States
(12) Patent Application Publication
(10) Pub. No.: US 2013/0266030 A1
(43) Pub. Date: Oct. 10, 2013

(54) Device and Method for Transmitting and Receiving Data

(71) Applicant: NOVATEK MICROELECTRONICS CORP., Hsin-Chu (TW)

(72) Inventors: Chia-Wei Su, Hsinchu City (TW); Shun-Hsun Yang, Hsinchu City (TW); Hsin-Hung Lee, Kaohsiung City (TW); Po-Hsiang Fang, Hsinchu City (TW); Po-Yu Tseng, Taoyuan County (TW); Li-Tang Lin, Hsinchu City (TW)

(73) Assignee: NOVATEK Microelectronics Corp., Hsin-Chu (TW)

(21) Appl. No.: 13/684,576

(22) Filed: Nov. 26, 2012

(30) Foreign Application Priority Data
Apr. 9, 2012 (CN) 201210101795.6

(51) Int. Cl. H04J 3/00

(52) U.S. Cl. CPC H04J 3/00
USPC 370/537; 370/542

(57) ABSTRACT

A data transmission device includes a data division unit for receiving an original transmission data and dividing the original transmission data into a plurality of division data; a data generation unit for generating a plurality of packet data according to the plurality of division data and a plurality of clock data, wherein each of the clock data is a multi-bit data; and a data output unit for outputting the plurality of packet data to a data reception device; where each of the packet data includes a division data and a clock data, each of the packet data corresponds to a packet data period, and the division data corresponds to a division data period of the packet data period and the clock data corresponds to a clock period of the packet data period.

### BACKGROUND OF THE INVENTION

1. Field of the Invention

The present invention relates to a device and a method for transmitting and receiving data, and more particularly, to a device and a method for transmitting and receiving data comprising clock data and transmission data.

2. Description of the Prior Art

While the transmitter and the receiver share transmission data, transmission/reception data mechanisms are required and clock data for transmission/reception mechanism are needed as well. During high-speed-interface data transmission, it is necessary to encode the transmission data and clock data, so as to improve transmission quality, reduce electromagnetic interference, provide error correction and save related clock circuits.

For clock signal reconstruction, the conventional clock embedded interface usually adds clock data into the transmission data/commands for restoring the clock signals, so as to functionally operate the clock signals of the operating system (OS). However, the above operation may limit data transmission efficiency because of adding the extra clock data for data transmission. Therefore, it has become an important issue to provide other efficient clock data designs or encoding means/processes, so as to improve transmission efficiency as well as broaden product application.

### SUMMARY OF THE INVENTION

It is therefore an objective of the invention to provide a device and a method for transmitting and receiving data simultaneously including clock data and packet information.

The present invention discloses a data transmission device comprising a data division unit for receiving an original transmission data and dividing the original transmission data into a plurality of division data, a data generation unit for generating a plurality of packet data according to the plurality of division data and a plurality of clock data, wherein each of the clock data is a multi-bit data, and a data output unit for outputting the plurality of packet data to a data reception device, wherein each of the packet data includes a division data and a clock data, each of the packet data corresponds to a packet data period, and the division data corresponds to a division data period of the packet data period and the clock data corresponds to a clock period of the packet data period.

The present invention also discloses another transmission method comprising receiving an original transmission data and dividing the original transmission data into a plurality of division data, generating a plurality of packet data according to the plurality of division data and a plurality of clock data, wherein each of the clock data is a multi-bit data, and outputting the plurality of packet data to a data reception device, wherein each of the packet data includes a division data and a clock data, each of the packet data corresponds to a packet data period, and the division data corresponds to a division data period of the packet data period and the clock data corresponds to a clock period of the packet data period.

The present invention also discloses another data reception device comprising a data reception unit for receiving a plurality of packet data from a data transmission device, a data retrieval unit for retrieving a division data according to a clock data of each of the plurality of packet data, wherein the clock data is a multi-bit data, and a data combination unit for combining the division data retrieved by the data retrieval unit to be an original transmission data, wherein each of the packet data includes a division data and a clock data, each of the packet data corresponds to a packet data period, and the division data corresponds to a division data period of the packet data period and the clock data corresponds to a clock period of the packet data period.

The present invention also discloses another data reception method comprising receiving a plurality of packet data from a data transmission device, retrieving a division data according to a clock data of each of the plurality of packet data, wherein the clock data is a multi-bit data, and combining the division data retrieved by a data retrieval unit to be an original transmission data, wherein each of the packet data includes a division data and a clock data, each of the packet data corresponds to a packet data period, and the division data corresponds to a division data period of the packet data period and the clock data corresponds to a clock period of the packet data period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a data transmission system according to an embodiment of the invention.

FIG. 2 illustrates a schematic diagram of a packet data according to an embodiment of the invention.

FIG. 3 illustrates a schematic diagram of another packet data according to an embodiment of the invention.

FIG. 4 illustrates a schematic diagram of a command look-up table including different types of packet data shown in FIG. 2 according to an embodiment of the invention.

FIG. 5 illustrates a schematic diagram of another command look-up table of the packet data in FIG. 3 according to an embodiment of the invention.

FIG. 6 illustrates a flowchart of a data transmission process according to an embodiment of the invention.

FIG. 7 illustrates a flow chart of a data reception process according to an embodiment of the invention.

### DETAILED DESCRIPTION

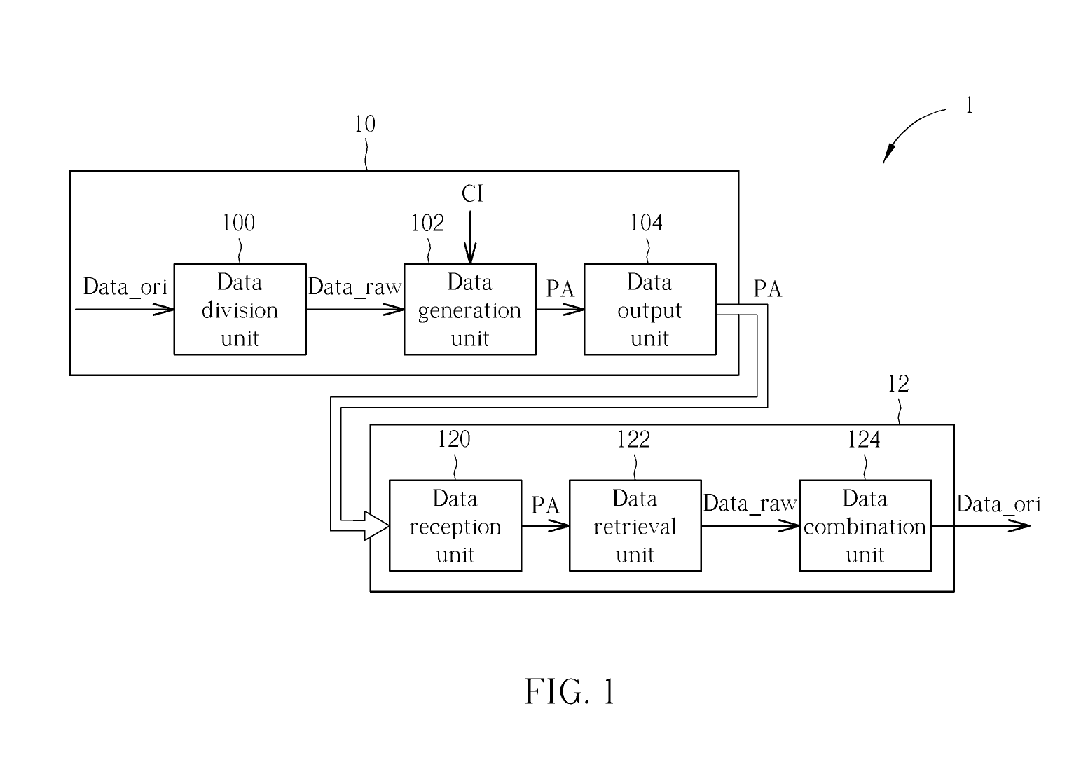

In the embodiment, a data transmission system is set up including a data transmission device 10 and a data reception device 12, as shown in FIG. 1. The data transmission device 10 includes a data division unit 100, a data generation unit 102 and a data output unit 104. The data reception device 12 includes a data reception unit 120, a data retrieval unit 122 and a data combination unit 124. Also, the data transmission device 10 and the data reception device 12 set up a data transmission mechanism via a wired/wireless transmission process for data transmission.

In detail, the data transmission device 10 utilizes the data division unit 100 to receive an original transmission data Data_ori. The original transmission data Data_ori includes original data and/or original transmission commands, which is not limited hereinafter. The data division unit 100 divides the original transmission data Data_ori into a plurality of division data Data_raw according to a predetermined transmission protocol or other adjustable transmission protocol for different users' requirements, so as to transmit the division data Data_raw to the data generation unit 102. The data generation unit 102 simultaneously receives or generates at least a clock data CI and receives the plurality of division data Data_raw, so as to form a packet data PA via the clock data CI and the plurality of division data Data_raw and provide the packet data PA to the data output unit 104. The data output unit 104 sequentially transmits all the packet data PA complying with the wired/wireless transmission process to the data reception unit 120 of the data reception device 12. Also, the data reception unit 120 complies with the wired/wireless transmission process to receive all the packet data PA for being inputted into the data retrieval unit 122. The data retrieval unit 122 further includes a determination unit (not shown in the figure) for determining whether the clock data CI related to the data generation unit 102 is correctly received and a transmission format of the clock data CI complies with a predetermined transmission format or not. The data retrieval unit 122 further retrieves the division data Data₁₃ raw corresponding to the clock data CI within each of the packet data PA. Lastly, the data combination unit 124 includes a look-up table (not shown in the figure) combining the retrieved division data Data₁₃ raw as the original transmission data Data₁₃ ori, so as to complete the data transmission between the data transmission device 10 and the data reception device 12.

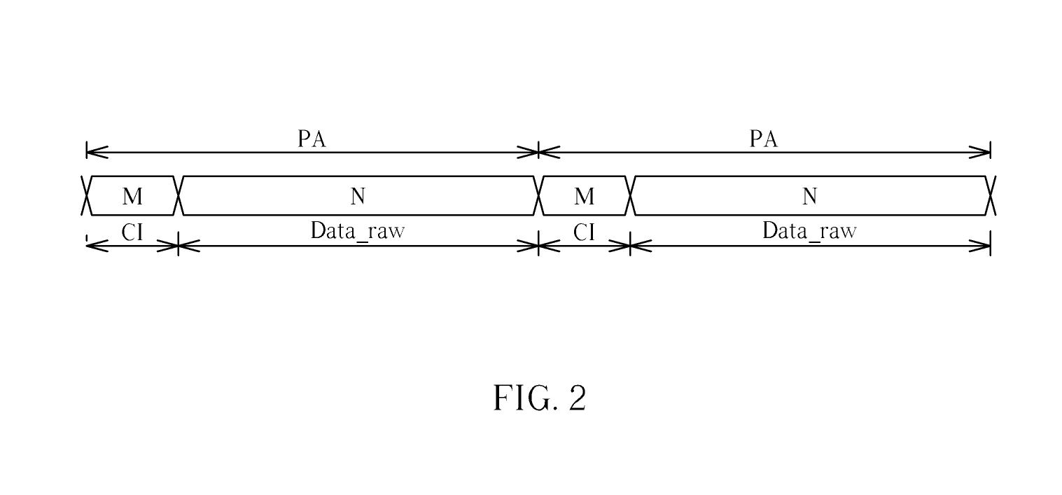

Please refer to FIG. 2, which illustrates a schematic diagram of a packet data PA according to an embodiment of the invention. In detail, the packet data PA complies with the wired/wireless transmission process between the data transmission device 10 and the data reception device 12, wherein only two packet data PA are demonstrated for explanation hereinafter, and each of the packet data PA includes a clock data CI and a division data Data₁₃ raw. The clock data CI includes a plurality of bits to form as a multi-bit data. The division data Data₁₃ raw is formed as at least one single-bit-length data. As shown in FIG. 2, the symbols M, N represent the bit number of the clock data CI and the division data Data₁₃ raw, respectively, wherein M≧2 and N≧1. Further, each of the packet data PA corresponds to a packet data period, and the packet data period includes a division data period and a clock period. The division data Data_raw corresponds to the division data period, and the clock data CI corresponds to the clock period. For the data transmission device 10, each of the packet data PA is transmitted at its corresponding period within the packet data period, which means that the division data Data_raw is transmitted at the division data period of the packet data period and the clock data CI is transmitted at the clock period of the packet data period as well. Noticeably, the clock period of the clock data CI, in the embodiment, leads the division data period of the division data Data₁₃ raw, which means that the clock period of the clock data CI locates ahead the division data Data₁₃ raw within each of the packet data PA. All the packet data PA sequentially connect to each other, i.e. the division data Data₁₃ raw of the prior packet data connects to the clock data CI of the lagging packet data. On the other hand, the clock information CI of the packet data PA is initially received in the data reception device 12, and then the division data Data_raw of the packet data PA is received. Thus, within each of the packet data PA, the data retrieval unit 122 retrieves the division data Data₁₃ raw after detecting the corresponding clock data CI.

From different perspective, there is an alternative formation of the packet data PA having the division data Data_raw of the prior packet data PA with the clock data CI of the lagging packet data PA to be combined for another new packet data and to have the clock period of the clock data CI lagging the division period of the division data Data₁₃ raw. In other words, within each of the new packet data PA, the clock data CI locates behind the division data Data₁₃ raw. The division data Data₁₃ raw of the packet data PA is initially received in the data reception device 12, and then the clock data CI is received. For each of the packet data PA, the data retrieval unit 122 retrieves the division data Data₁₃ raw after detecting the clock data CI of the prior packet data PA. Therefore, those skilled in the art can adaptively adjust positions of the division data Data_raw and the clock data CI within each of the packet data PA according to different users' requirements, which is not limited hereinafter.

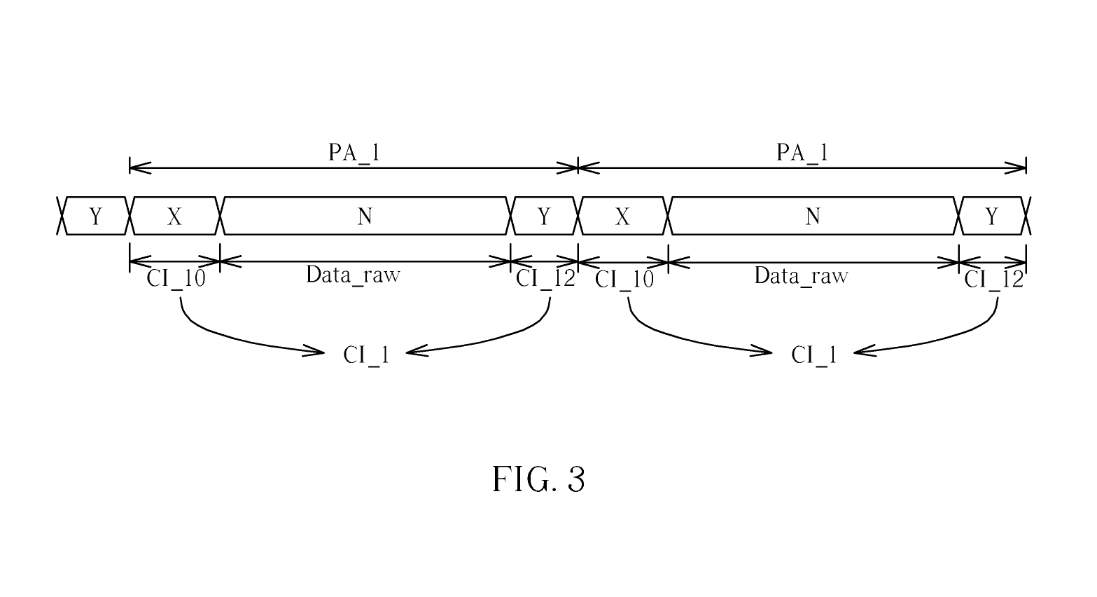

Noticeably, the positions of the division data Data_raw and the clock data CI within each of the packet data PA can be adaptively changed, and each of the clock data can further be divided as well. Please refer to FIG. 3, which illustrates a schematic diagram of another packet data PA_1 according to an embodiment of the invention. In comparison with the packet data PA in FIG. 2, each of the packet data PA_1 in FIG. 3 includes the division data Data₁₃ raw having N bits and the clock data CI_1. Also, the clock data CI_1 includes a leading clock data CI_10 having X bits and a lagging clock data CI_12 having Y bits. The division data Data₁₃ raw corresponds to the division data period, and the leading clock data CI_10 and the lagging clock data CI_12 correspond to a leading clock period and a lagging clock period, respectively. The leading clock period of the leading clock data CI_10 leads the division data period of the division data Data_raw, and the lagging clock period of the lagging clock data CI_12 lags the division data period of the division data Data_raw. In other words, the leading clock data CI_10 locates ahead the division data Data_raw, and the lagging clock data CI_12 locates behind the division data Data₁₃ raw. In the data reception device 12, the leading clock data CI_10, the division data Data₁₃ raw and the lagging clock data CI_12 are sequentially received, and the division data Data_raw is surrounded by the leading clock data CI_10 in front and lagging clock data CI_12 behind to form each of the packet data PA. Therefore, the data retrieval unit 122 retrieves the division data Data₁₃ raw after detecting the lagging clock data CI_12 of the prior packet data PA and leading clock data CI_10 of the leading clock data CI_10 of the current packet data PA.

In simple, the data transmission system 1, in the embodiment, sets up the wired/wireless transmission process between the data transmission device 10 and the data reception device 12, so as to encode the original transmission data Data₁₃ ori as the plurality of packet data PA. Each of the plurality of packet data PA includes the clock data CI and the division data Data₁₃ raw. According to different requirements, the user cab adaptively adjust the clock data CI positions to being in front of or in back of the division data Data_raw, or the clock data CI can also be divided into the leading clock data in front of the division data Data₁₃ raw and the lagging clock data and in back of the division data Data₁₃ raw, which is also in the scope of the invention. For each of the clock data CI in front of the division data Data₁₃ raw, it can be utilized to reconstruct a clock signal (not shown in the figure) of the data reception device 12, and can also be used to combine other multi-bit designs in different product application due to multi-bit characteristics. For example, the above clock data CI can be utilized to inform the user when the data reception device 12 is ready to receive the division data Data_raw. Or the above clock data CI can be transmitted as another command signal from the data transmission device 10 to the data reception device 12. In practice, last two bits of the multi-bit clock data CI can be set as 01. When the digital signal is transformed from 0 to 1, the transformation can be utilized as a triggering signal/mechanism, which is demonstrated as the moment for initiating the data transmission device 10 to transmit the packet data PA to the data reception device 12. When the data reception unit 120 receives the packet data PA, the determination unit of the data retrieval unit 122 then determines whether the packet data PA complies with the predetermined transmission format. Once the predetermined transmission format is determined, the data combination unit 124 is operated to restore the packet data PA back to the original transmission data Data₁₃ ori. For the high speed transmission system, the period of transformation of digital signal is so short that the data reception device 12 barely has sufficient responsive period to determine whether or not to receive the transmission data. Therefore, there is an alternative to set the last three bits of the multi-bit clock data CI as 001, which allows the clock data CI to have one more bit to wait for the transformation of the digital signal. Then, utilizing the transformation of the digital signal from 0 to 1, it can form the trigger to inform the data reception device 12 to receive the packet data PA, so as to avoid the user possibly losing the packet data PA as well as to improve transmission efficiency of the data transmission system 1.

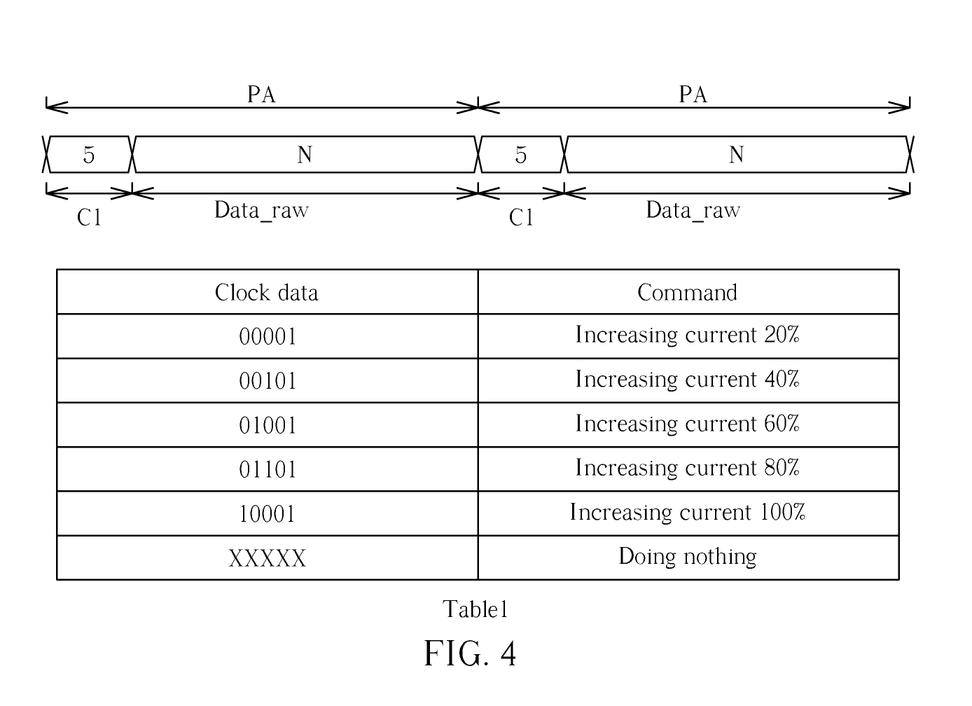

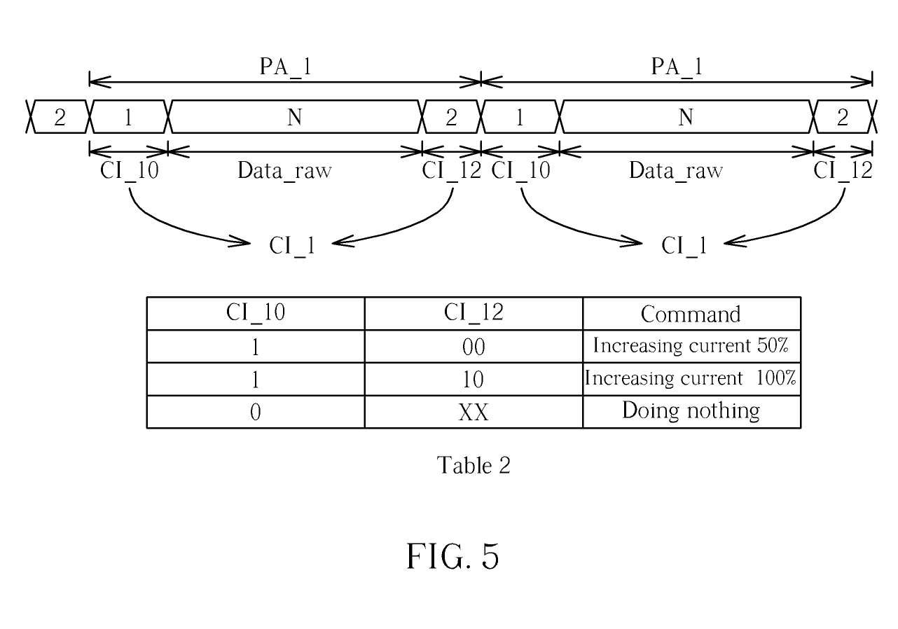

Moreover, the user can modify the clock data CI to be other types of multi-bit data, and the data transmission device 10 transmits the control command to the data reception device 12 accordingly. As can be seen from following embodiment, more can be understood. Please refer to FIG. 4, which illustrates a schematic diagram of a command look-up table Table1 including different types of packet data PA shown in FIG. 2 according to an embodiment of the invention. As shown in FIG. 4, the clock data CI of the packet data PA includes five bits, and the embodiment predetermines six commands for the five bits of the clock data CI, wherein the six commands correspond to 00001 for increasing current 20%, 00101 for increasing current 40%, 01001 for increasing current 60%, 01101 for increasing current 80%, 10001 for increasing current 100% and XXXXX for doing nothing, respectively. The user can match to a different command by changing the bit of the clock data CI, so as to directly control the operational current passing through the data reception device 12. Besides, please refer to FIG. 5, which illustrates a schematic diagram of another command look-up table Table2 of the packet data PA_1 in FIG. 3 according to an embodiment of the invention. As shown in FIG. 5, the clock data of the packet data PA_1 includes the leading clock data CI_10 having one bit and the lagging clock data CI_12 having two bits. In the embodiment, the command look-up table Table2 predetermines three commands for the three bits of the leading clock data CI_10 as well as the lagging clock data CI_12, and the three bits are 100 for increasing current 50%, 110 for increasing 100% and 0XX for doing nothing, respectively. Certainly, the command look-up tables Table1, Table2 in FIG. 4 and FIG. 5 can be modified/changed to comply with different combinations of the clock data, so as to form other corresponding commands, which is also in the scope of the invention.

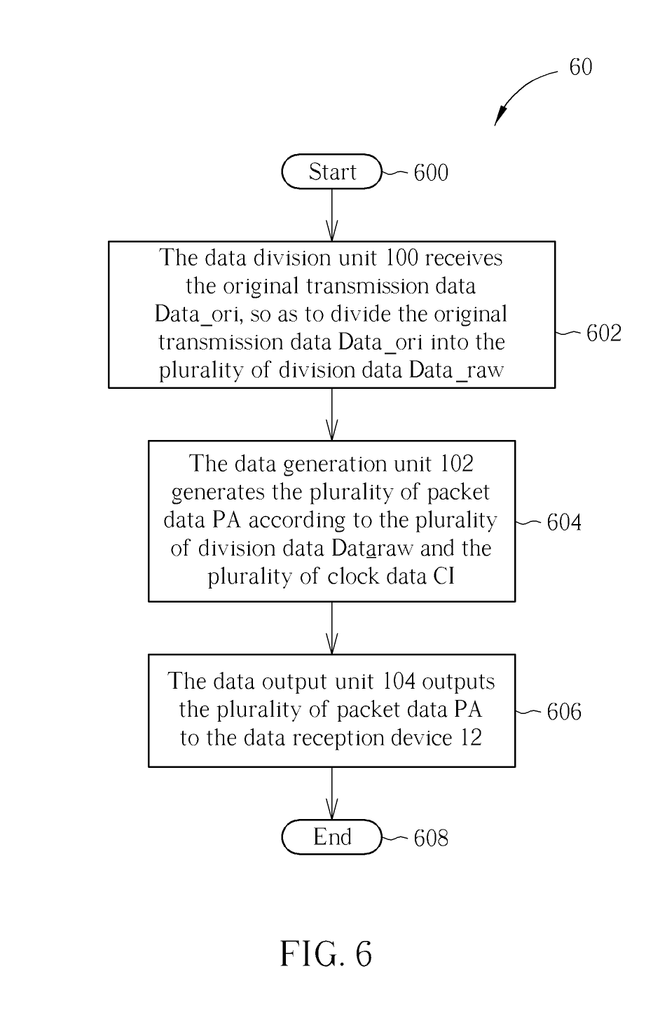

In the wired/wireless transmission process for the embodiment of the invention, the data transmission method for the data transmission device 10 can be summarized as a data transmission process 60, as shown in FIG. 6. The data transmission process 60 includes steps as follows:

Step 600: Start.

Step 602: The data division unit 100 receives the original transmission data Data₁₃ ori, so as to divide the original transmission data Data₁₃ ori into the plurality of division data Data₁₃ raw.

Step 604: The data generation unit 102 generates the plurality of packet data PA according to the plurality of division data Data₁₃ raw and the plurality of clock data CI.

Step 606: The data output unit 104 outputs the plurality of packet data PA to the data reception device 12.

Step 608: End.

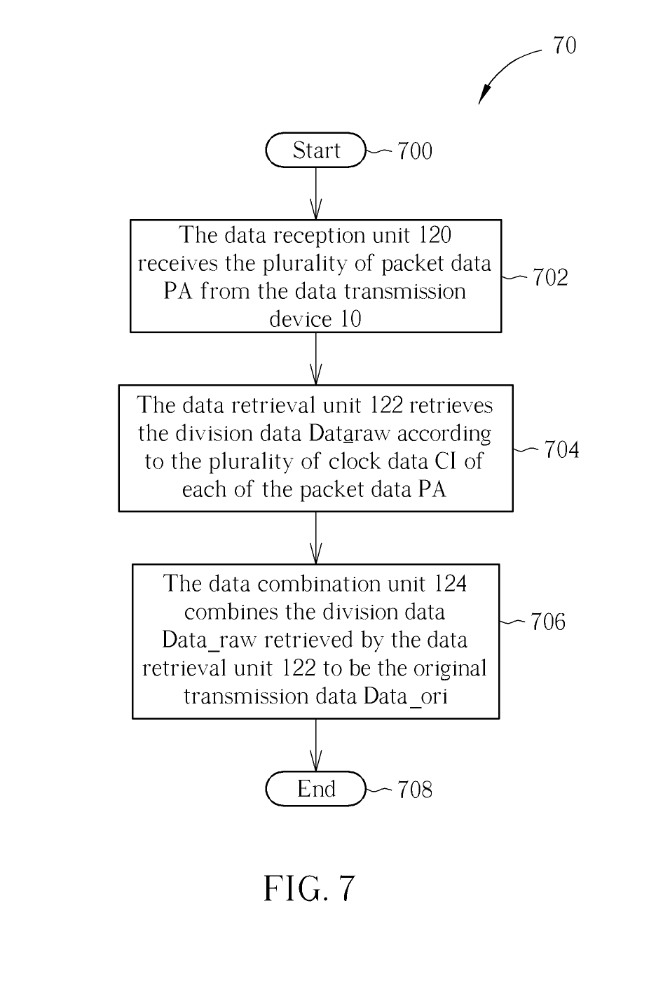

Furthermore, in the wired/wireless transmission process for the embodiment of the invention, the data reception method for the data reception device 12 can be summarized as a data reception process 70, as shown in FIG. 7. The data reception process 70 includes steps as follows:

Step 700: Start.

Step 702: The data reception unit 120 receives the plurality of packet data PA from the data transmission device 10.

Step 704: The data retrieval unit 122 retrieves the division data Data₁₃ raw according to the plurality of clock data CI of each of the packet data PA.

Step 706: The data combination unit 124 combines the division data Data₁₃ raw retrieved by the data retrieval unit 122 to be the original transmission data Data₁₃ ori.

Step 708: End.

The data transmission process 60 and the data reception process 70 can be applied to the data transmission device 10 and the data reception device 12 in the data transmission system 1 for the wired/wireless transmission process. By adjusting positions of the clock data CI related to the division data Data₁₃ raw, the packet data PA can be formed for data transmission, so as to transmit the original transmission data Data₁₃ ori. The detailed steps of the data transmission process 60 and the data reception process 70 can be understood via FIG. 1 to FIG. 5 and related paragraphs of the above embedment, which is not described hereinafter.

In summary, the invention provides a device and a method for data transmission and reception, which divides an original transmission data into a plurality of division data and simultaneously receives a plurality of clock data, so as to encode the plurality of division data as well as the plurality of clock data to form a plurality of packet data and to set up a wired/wireless transmission process between a data transmission device and a data reception device in a data transmission system. Certainly, users can modify/design/change combinations of the clock data being utilized to set up a clock signal of the data reception device, or to be formed as a command signal from the data transmission device to the data reception device for controlling the data reception device. Thus, the embodiment of the invention improves the transmission efficiency between the data transmission device and the data reception device, and product application of the data transmission system can also be broadened.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data transmission device comprising:
a data division unit for receiving an original transmission data and dividing the original transmission data into a plurality of division data;
a data generation unit for generating a plurality of packet data according to the plurality of division data and a plurality of clock data, wherein each of the clock data is a multi-bit data; and
a data output unit for outputting the plurality of packet data to a data reception device;
wherein each of the packet data includes a division data and a clock data, each of the packet data corresponds to a packet data period, and the division data corresponds to a division data period of the packet data period and the clock data corresponds to a clock period of the packet data period.

2. The data transmission device of claim 1, wherein the clock period leads the division data period within each of the packet data periods.

3. The data transmission device of claim 1, wherein the clock period lags the division data period within each of the packet data periods.

4. The data transmission device of claim 1, wherein, within each of the packet data, the clock data comprises a leading clock data and a lagging clock data, the clock period comprises a leading clock period and a lagging clock period, and the leading clock data corresponds to the leading clock period and the lagging clock data corresponds to the lagging clock period.

5. The data transmission device of claim 4, wherein the leading clock period leads the division data period and the lagging clock period lags the division data period.

6. The data transmission device of claim 1, wherein last two bits of each of the clock data are 01.

7. A data transmission method comprising:
receiving an original transmission data and dividing the original transmission data into a plurality of division data;
generating a plurality of packet data according to the plurality of division data and a plurality of clock data, wherein each of the clock data is a multi-bit data; and
outputting the plurality of packet data to a data reception device;
wherein each of the packet data includes a division data and a clock data, each of the packet data corresponds to a packet data period, and the division data corresponds to a division data period of the packet data period and the clock data corresponds to a clock period of the packet data period.

8. The data transmission method of claim 7, wherein the clock period leads the division data period within each of the packet data periods.

9. The data transmission method of claim 7, wherein the clock period lags the division data period within each of the packet data periods.

10. The data transmission method of claim 7, wherein, within each of the packet data, the clock data comprises a leading clock data and a lagging clock data, the clock period comprises a leading clock period and a lagging clock period, and the leading clock data corresponds to the leading clock period and the lagging clock data corresponds to the lagging clock period.

11. The data transmission method of claim 10, wherein the leading clock period leads the division data period and the lagging clock period lags the division data period.

12. The data transmission method of claim 7, wherein last two bits of each of the clock data are 01.

13. A data reception device comprising:
a data reception unit for receiving a plurality of packet data from a data transmission device;
a data retrieval unit for retrieving a division data according to a clock data of each of the plurality of packet data, wherein the clock data is a multi-bit data; and
a data combination unit for combining the division data retrieved by the data retrieval unit to be an original transmission data;
wherein each of the packet data includes a division data and a clock data, each of the packet data corresponds to a packet data period, and the division data corresponds to a division data period of the packet data period and the clock data corresponds to a clock period of the packet data period.

14. The data reception device of claim 13, wherein the data retrieval unit initiates to retrieve the division data from the packet data while determining last two bits of each of the clock data are 01.

15. The data reception device of claim 13, wherein, within each of the packet data, the clock data comprises a leading clock data and a lagging clock data, the clock period comprises a leading clock period and a lagging clock period, and the leading clock data corresponds to the leading clock period and the lagging clock data corresponds to the lagging clock period.

16. The data reception device of claim 15, wherein the leading clock period leads the division data period, the lagging clock period lags the division data period, and the data retrieval unit retrieves the division data according to the lagging clock data of the prior packet data and the leading clock data of the current packet data.

17. A data reception method comprising:
receiving a plurality of packet data from a data transmission device;
retrieving a division data according to a clock data of each of the plurality of packet data, wherein the clock data is a multi-bit data; and
combining the division data retrieved by a data retrieval unit to be an original transmission data;
wherein each of the packet data includes a division data and a clock data, each of the packet data corresponds to a packet data period, and the division data corresponds to a division data period of the packet data period and the clock data corresponds to a clock period of the packet data period.

18. The data reception method of claim 17, wherein the step of retrieving the division data according to the clock data of each of the plurality of packet data further comprises:
initiating to retrieve the division data from the packet data while determining last two bits of each of the clock data are 01.

19. The data reception device of claim 17, wherein, within each of the packet data, the clock data comprises a leading clock data and a lagging clock data, the clock period comprises a leading clock period and a lagging clock period, and the leading clock data corresponds to the leading clock period and the lagging clock data corresponds to the lagging clock period.

20. The data reception device of claim 19, wherein the step of retrieving the division data according to the clock data of each of the plurality of packet data further comprises:
retrieving the division data according to the lagging clock data of the prior packet data and the leading clock data of the current packet data, wherein the leading clock period leads the division data period and the lagging clock period lags the division data period.
